(19) United States
(12) Patent Application Publication
(10) Pub. No.: US 2013/0183075 A1
(43) Pub. Date: Jul. 18, 2013

(54) APPARATUS FOR ADJUSTING PRINT WIDTH IN POS PRINTER

(71) Applicants: Jin-Gwan KIM, Yongin-si (KR); Kyoung-Seob SONG, Yongin-si (KR)

(72) Inventors: Jin-Gwan KIM, Yongin-si (KR); Kyoung-Seob SONG, Yongin-si (KR)

(73) Assignee: BIXOLON CO.,LTD., Seongnam-si (KR)

(21) Appl. No.: 13/407,840

(22) Filed: Feb. 29, 2012

(30) Foreign Application Priority Data
Jan. 16, 2012 (KR) 10-2012-0004881

(51) Int. Cl. B41J 15/04

(52) U.S. Cl. 400/619

(57) ABSTRACT

An apparatus for adjusting a print width in a POS printer, such as a facsimile or a printer, in which the paper is wound in the form of a roll, so that the printer can selectively use various types of paper that is be supplied thereto. The apparatus includes a paper guide, the position of which is adjustable depending on the width size of a paper to be supplied, and a contact switching means for detecting the width of the paper. The apparatus automatically detects the width of the paper with a simple operation in which the paper is inserted between or taken out of the printer, and thus automatically sets the print width to be the same as the width of the paper, so that printing is performed on the paper.

### CROSS REFERENCE TO RELATED APPLICATION

The present application claims priority from Korean Patent Application Number 10-2012-0004881 filed on Jan. 17, 2012, the entire contents of which application are incorporated herein for all purposes by this reference.

### BACKGROUND OF THE INVENTION

1. Field of the Invention

The present invention relates to an apparatus for adjusting a print width in a point-of-sale (POS) printer, and more particularly, to an apparatus for adjusting a print width in a POS printer, such as a facsimile or a printer, in which the paper is wound in the form of a roll, so that the printer can selectively use various types of paper that is be supplied thereto. The apparatus includes a paper guide, the position of which is adjustable depending on the width size of a paper to be supplied, and a contact switching means for detecting the width of the paper. The apparatus automatically detects the width of the paper with a simple operation in which the paper is inserted between or taken out of the printer, and thus automatically sets the print width to be the same as the width of the paper, so that printing is performed on the paper.

2. Description of Related Art

As is well known in the art, devices, such as an electronic cash register (ECR), a point-of-sale (POS) terminal or a credit card terminal, which can register the details of a transaction, calculate sales prices and taxes, and/or issue a receipt (receipt paper), are used in some places, such as convenient stores, supermarkets, restaurants, and department stores.

Here, in order to issue the receipt, the electric cash register, POS terminal, or the credit card terminal uses a small printer (or a receipt printer), which is provided therein, as a device that prints out the details of a receipt.

Such a small printer can be divided into a dot printer and a thermal printer depending on the printing schemes. The dot printer is adapted to print the details of the transaction on a sheet of paper by striking a running ribbon against the paper.

Here, the electric cash register, which is generally used in convenient stores, supermarkets, restaurants, and the like, outputs the details of the transaction through a display when the details of a product (or price) is input using a keyboard or a scanner.

The details of the transaction, which are output through the display, are then printed out on a roll of paper (the paper of the electric cash register is provided a roll, and is referred to as “paper” hereinafter) by the printer of the electric cash register. After that, a piece of paper for a recipient is pushed out.

At the same time, the details of the transaction are printed on another paper for inspection, which is wound into the form of a roll and is stored inside the printer of the electric cash register, so that they can be used later for the purpose of inspection. Alternatively, the details of the transaction are remembered in fiscal memory having the form of a chip, which is provided inside the printer of the electric cash register.

The above-mentioned small printer, which is provided inside the electric cash register, is used to issue a receipt on which a trade name or a price is printed. The small printer includes a printer body, a paper supply section provided inside the printer body, a printing section for printing the trade name or the price on a paper, a guide device for guiding the paper to the printing section in order to facilitate printing, and a cutting section for cutting the paper at a suitable length when the printing is finished.

Here, types of the paper, which are widely used in the small printer, typically include a paper that has a width of 2 inches and a paper that has a width of 3 inches. The paper is wound in the form of a roll, which is rotatably loaded inside the printer, so that the paper can be continuously used.

In the related art, a variety of types of paper guide device for a small printer has been proposed in order to use both the paper having a 2 inch width and the paper having a three inch width in one printer. Such a guide device enables it by adjusting a print width depending on the width of the paper.

However, most of such paper guide devices for a small printer, which were proposed in the related art, have drawbacks since related components are separately fabricated depending on the variable width of the paper and are then assembled. Therefore, the assembly work is complicated and the fabrication and development cost is increased, thereby making the paper guide devices expensive.

In a related art, Korean Patent Application Publication No. 10-2002-0024494 (filed May 3, 2002) disclosed “a paper guide device for a mini printer,” which will be described below with reference to FIG. 1 and FIG. 2.

As shown in FIG. 1 and FIG. 2, the paper guide device for a mini printer of the related art includes a low guide frame 100, which is provided on a body portion of the mini printer. The paper guide device also includes an upper guide frame 200, which is fixedly assembled to the front surface of the low guide frame 100, such that it faces the low guide frame with an interval that allows a roll of paper to pass through. A pair of guide pieces 220, which are spaced apart from each other at an interval the same as the width of a first paper P1, protrudes from the rear surface of the upper guide frame 200 in order to guide the first paper P1. The paper guide device also includes an auxiliary guide 300, which is provided between the guide pieces 220. The auxiliary guide 300 is selectively detachably coupled to the upper guide frame 200, at a position that is spaced apart from one of the guide pieces 220 at an interval the same as the width of a second paper P2, which is smaller than the width of the first paper P1, such that it cooperates with one of the guide pieces 220 to guide the second paper P2.

However, the paper guide device for a mini printer of the related art has the problem of inconvenience. Specifically, the auxiliary guide 300, which must be detachably coupled and adjusted depending on the width of the paper, is not easily disassembled when detaching it from the paper guide device.

In particular, since the auxiliary guide 300, which adjusts the width of the paper, is a separate part, it must be kept by a user when a different paper width is used, so that it can be used in the future when required. However, the auxiliary guide may be lost while it is being in the custody.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an apparatus for adjusting a print width in a point-of-sale (POS) printer, such as a facsimile or a printer, in which a paper is wound in the form of a roll, so that the printer can selectively use various types of paper that is be supplied thereto. The apparatus includes a paper guide, the position of which is adjustable depending on the width size of a paper to be supplied, and a contact switching means for detecting the width of the paper. The apparatus automatically detects the width of the paper with a simple operation in which the paper is inserted between or taken out of the printer, and thus automatically sets the print width to be the same as the width of the paper, so that printing is performed on the paper.

In an aspect of the present invention, the apparatus for adjusting a print width in a POS printer includes a printer body having a printing head, the printer body containing a paper therein; a cover frame rotatably connected to an upper portion of the printer body, such that the upper portion of the printer body is opened and closed in order to replace the paper, the cover frame having a roller disposed on one end thereof; a support frame coupled to an inside of the printer body, the support frame containing and holding the paper in an upper portion thereof, and supplying the paper to the printing head; a contact switching means including a plurality of switch contacts at a plurality of positions that correspond to different width sizes of the paper to be inserted into the support frame, wherein the contact switching means is electrically connected or disconnected depending on a respective width size of the paper, thereby detecting the respective width size of the paper; a paper guide capable of reciprocating in a lateral direction on the support frame, wherein the position of the paper guide is adjustable depending on the respective width size of the paper detected by the switch contacts, so that the paper guide supports the paper; and a control section, wherein the control section recognizes the respective width size of the paper detected by the switch contacts, and sets and controls the print width.

In an exemplary embodiment, in the contact switching means, each of the switch contacts may be electrically connected when one edge of the paper is brought close thereto depending on the respective width size of the paper, and be electrically disconnected when one edge of the paper is not close thereto or is covered by the paper.

In an exemplary embodiment, in the contact switching means, positions of the switch contacts may be adjusted in the lateral direction on the support frame.

According to embodiments of the invention, the apparatus automatically detects the width of the paper with a simple operation in which the paper is inserted between or taken out of the paper guides, and thus automatically sets the print width to be the same as the width of the paper, so that printing is performed on the paper.

Furthermore, the convenience of a user can be increased since the width of the paper is easily adjustable by the user. When a variety types of paper is selectively used, the paper can be correctly guided to the printing head without shaking, thereby improving the quality of printing.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is an exploded perspective view showing the configuration of a paper guide device for a mini printer of the related art;

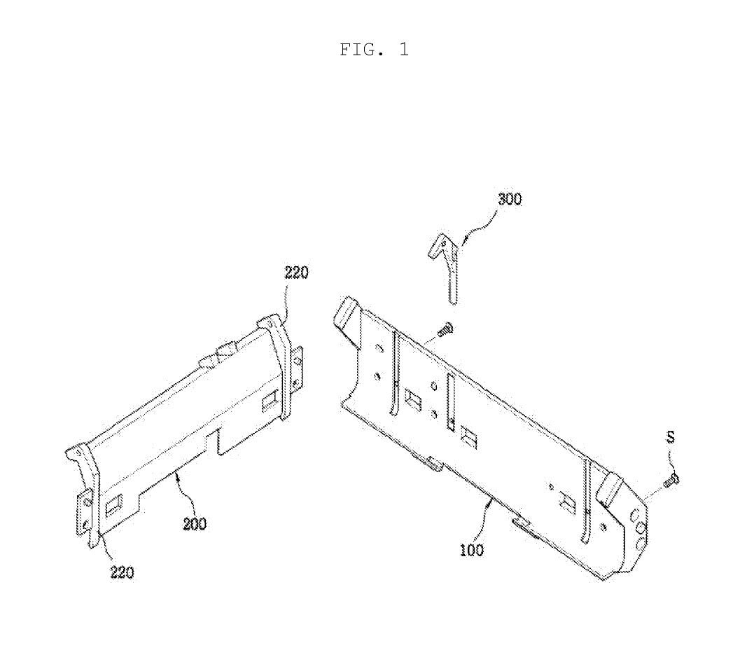

FIG. 2 is a front elevation view depicting the state in which the width of the guide, which is assembled to the paper guide device of the related art, is changed depending on the width of a paper;

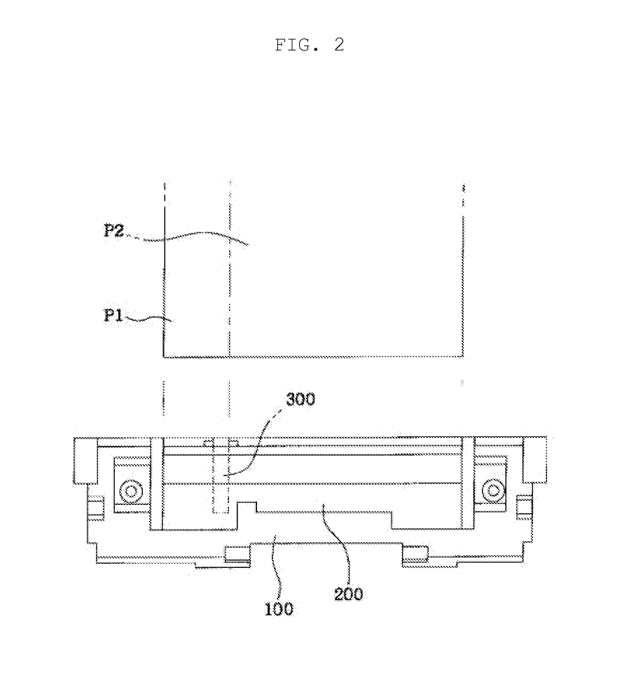

FIG. 3 is a configuration view showing a printer that includes an apparatus for adjusting a print width according to an exemplary embodiment of the invention;

FIG. 4 is a perspective view showing an apparatus for adjusting a print width according to an exemplary embodiment of the invention;

FIG. 5 is a front elevation view of the switch contact of the apparatus for adjusting a print width according to an exemplary embodiment of the invention;

FIG. 6 is a perspective view of the paper guide of the apparatus for adjusting a print width according to an exemplary embodiment of the invention;

FIG. 7 is a perspective view depicting that the paper guide of the apparatus for adjusting a print width according to an exemplary embodiment of the invention is displaced;

FIG. 8 is a view depicting that the apparatus for adjusting a print width according to an exemplary embodiment of the invention detects a paper width of 58 mm;

FIG. 9 is a view depicting that the apparatus for adjusting a print width according to an exemplary embodiment of the invention detects a paper width of 80 mm; and

FIG. 10 is a view depicting that the apparatus for adjusting a print width according to an exemplary embodiment of the invention detects a paper width of 83 mm.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

The purpose of this invention has been achieved by providing an apparatus for adjusting a print width in a POS printer that includes a printer body having a printing head, the printer body containing a paper therein; a cover frame rotatably connected to an upper portion of the printer body, such that the upper portion of the printer body is opened and closed in order to replace the paper, the cover frame having a roller disposed on one end thereof; a support frame coupled to an inside of the printer body, the support frame containing and holding the paper in an upper portion thereof, and supplying the paper to the printing head; a contact switching means including a plurality of switch contacts at a plurality of positions that correspond to different width sizes of the paper to be inserted into the support frame, wherein the contact switching means is electrically connected or disconnected depending on a respective width size of the paper, thereby detecting the respective width size of the paper; a paper guide capable of reciprocating in a lateral direction on the support frame, wherein the position of the paper guide is adjustable depending on the respective width size of the paper detected by the switch contacts, so that the paper guide supports the paper; and a control section, wherein the control section recognizes the respective width size of the paper detected by the switch contacts, and sets and controls the print width.

Hereinafter an exemplary embodiment of the invention will be described in detail with reference to the accompanying drawings.

In the meantime, terms and words used in the description and the claims should not be interpreted as ordinary or dictionary meanings, but as meanings and concepts conforming to the technical spirit of this invention based on the principle that an inventor may properly define the concept of the terms in his own discretion to describe the invention in the best way.

As the embodiment explained in this description and the construction shown in the drawings only suggest one most preferred embodiment and do not present all technical spirits of the present invention, it must be understood that diverse equivalences and modifications that can replace them were possible at the time when the invention was made.

The apparatus for adjusting a print width according to an exemplary embodiment of the invention is used in a POS printer, such as a facsimile or a printer, in which the paper is wound in the form of a roll, so that the facsimile or the printer which can selectively use various types of paper that is be supplied thereto. The apparatus includes a paper guide, the position of which is adjustable depending on the width size of a paper to be supplied, and a contact switching means for detecting the width of the paper. The apparatus automatically detects the width of the paper with a simple operation in which the paper is inserted between or taken out of the printer, and thus automatically sets the print width to be the same as the width of the paper, so that printing is performed on the paper.

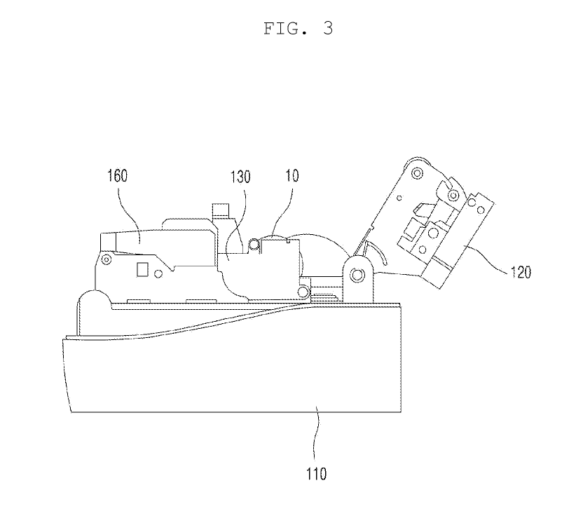

Referring to FIG. 3 to FIG. 6, the apparatus for adjusting a print width in a POS printer according to an exemplary embodiment of the invention generally includes a printer body 110, a cover frame 120, a support frame 130, switch contacts 140 of a contact switching means, a paper guide 150, and a control section 160.

First, the printer body 110 contains a roll of paper 10 therein, and is provided with a printing head.

The cover frame 120 is coupled to the upper portion of the printer body 110. The cover frame 120 is rotatably connected to the printer body 110 and has rollers on one end thereof, such that it can be opened and closed, so that the paper 10 can be replaced from the printer body 110.

The rollers are rotatably provided on the cover frame 120, and a drive motor, which rotates the rollers, is also provided on the cover frame 120.

The support frame 130, which contains and holds the paper 10 therein, is coupled to the inside of the printer body 110 that has the basic configuration as described above. The support frame 130 supplies the paper 10 to the printing head while supporting the paper 10.

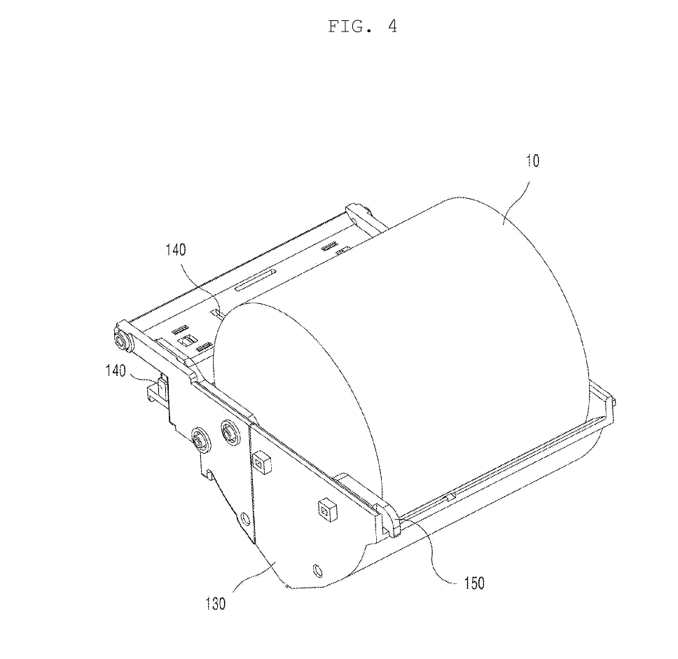

In addition, as shown in FIG. 4, the contact switching means includes the switch contacts 140 in order to detect the width size of the paper 10, which is loaded in the support frame 130. The paper guide 150 is provided inside the support frame 130, such that it can support the paper 10 in variable positions.

This configuration is intended to detect the dimension (width) of the paper 10, which is used in the POS printer.

Here, the control section 160, which sets the contact switching means and the paper guide 150 and the printing range, is provided for the purpose of control over these components.

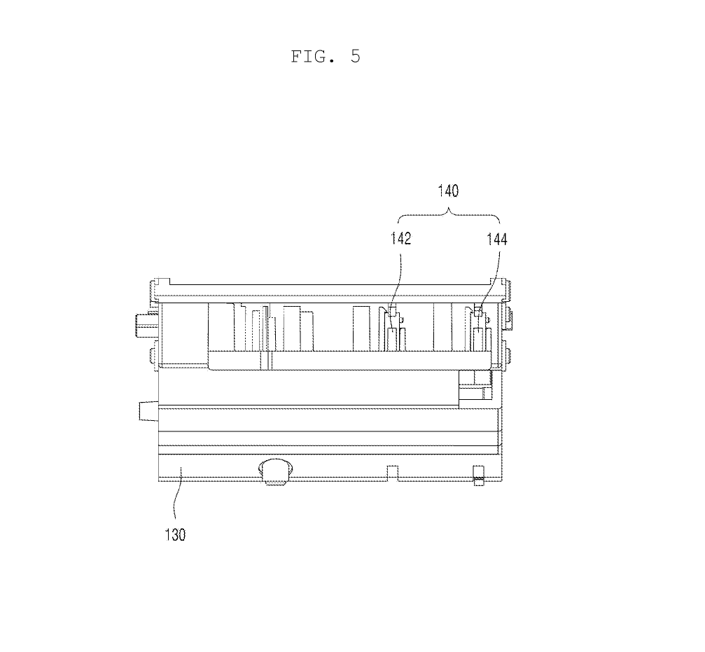

As shown in FIG. 5, the contact switching means is provided in order to detect the width size of the paper 10, which is loaded in the support frame 130.

The contact switching means includes the switch contacts 140, which are electrically connected or disconnected depending on the width size of the paper 10, thereby detecting the width of the paper 10.

In this contact switching means, each switch contact 140 is electrically connected or disconnected depending on the width size of the paper 10. That is, the witch contact 140 is electrically connected when one edge of the paper 10 is brought close thereto, but is electrically disconnected when one edge of the paper 10 is not close thereto or is covered by the paper 10.

Furthermore, in the contact switching means, the switch contacts 140 include a plurality of switch contacts 142 and 144, which are disposed at a plurality of positions that correspond to different width sizes of the paper 10.

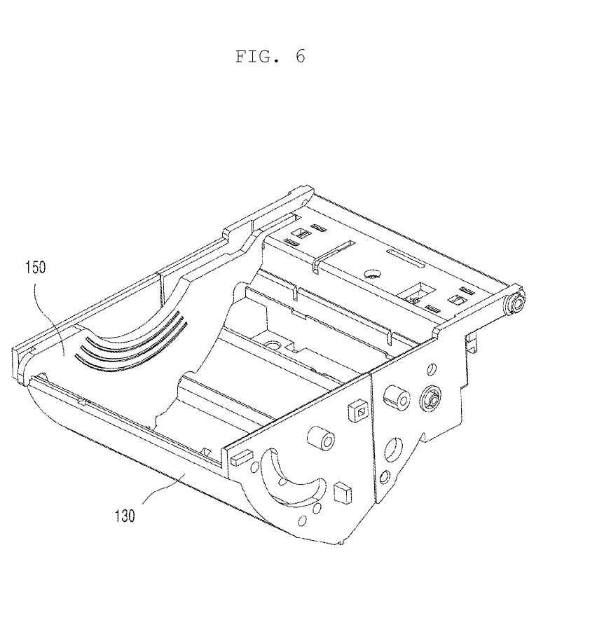

As shown in FIG. 6, the paper guide 150 is configured such that it can reciprocate in the lateral direction on the support frame 130. The position of the paper guide 150 is adjustable depending on the width size of the paper 10, which is detected by the switch contact, so that the paper guide 150 supports the paper 10.

In addition, the control section 160, as shown in FIG. 3, recognizes the width size of the paper 10, which is detected by the switch contact 140, and then sets and controls the print width.

The control section 160 is a control device that generates a combined signal in response to the switch contacts 140 detecting the paper 10, and transmits the combined signal to a main control unit (not shown) of the printer. In this fashion, the control section 160 automatically detects the width of the paper, and sets the print width when printing is performed.

The control section 160 also detects a signal from the switch contact 140, and automatically converts values that are set in a utility program.

Describing in more detail, the support frame 130 forms a place in which the paper 10 is stored.

The paper guide 150, which is displaceable in the lateral direction on the support frame 130, serves to guide the paper 10 to the right or left depending on the width size of the paper 10.

In addition, the contact switching means is provided on the support frame 130, such that the switch contacts 140 are electrically connected and disconnected depending on the width size of the paper 10.

Here, the switch contacts 140 are assembled to a separate bracket, by which the switch contacts 140 are connected to the paper guide 150.

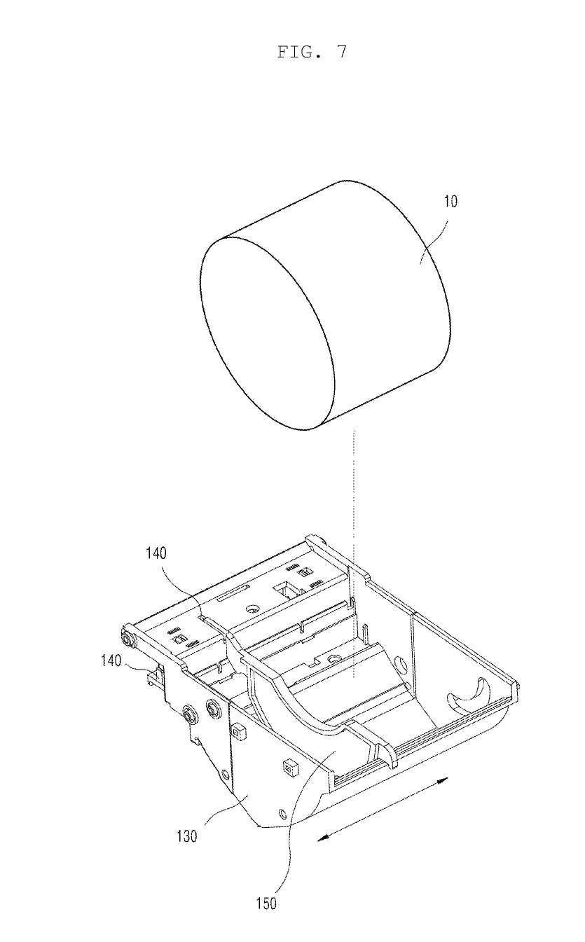

As shown in FIG. 7, the switch contacts 140 detect the width size of the paper 10, which is 58 mm, 80 mm, or 83 mm, so that the paper guide 150 is displaced depending on the detected width size.

TABLE 1

| Paper width | 1^{st} switch contact | 2^{nd} switch contact |
|---|---|---|
| 58 mm | ON | OFF |
| 80 mm | OFF | ON |
| 83 mm | OFF | OFF |

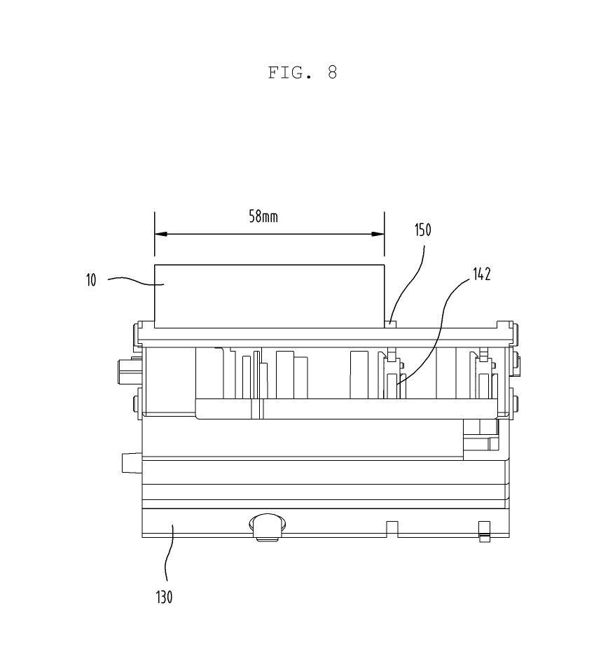

Referring to Table 1, when the paper 10 having a 58 mm width is used, the first switch contact 142 is switched on but the second switch contact 144 is switched off by the 58 mm paper 10, which is inserted into the support frame 130, as shown in FIG. 8. This information is transferred to the control section 160, which in turn sets the print width to 58 mm, so that the printing head can perform printing by the print width of 58 mm in the state in which the paper guide 150 is displaced to the position corresponding to the 58 mm width in order to support the paper.

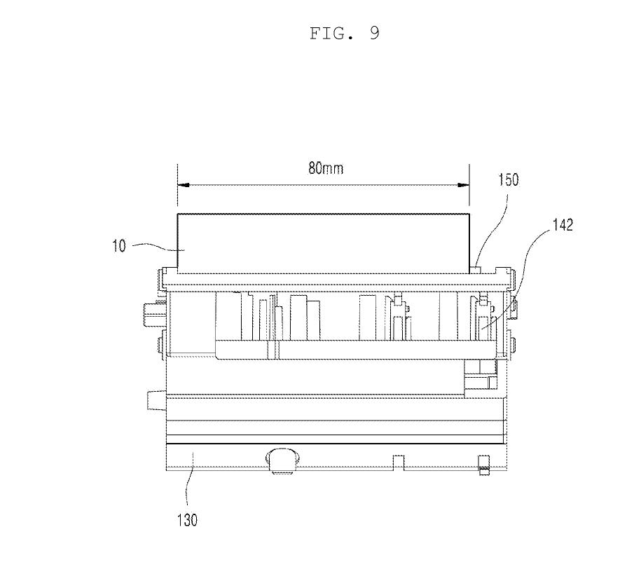

When the paper having an 80 mm width is used, as shown in FIG. 9, the first switch contact 142 is switched off but the second switch contact 144 is switched on by the 80 mm paper 10, which is inserted into the support frame 130. This information is transferred to the control section 160, which in turn sets the print width to 80 mm, so that the printing head can perform printing by the print width of 80 mm in the state in which the paper guide 150 is displaced to the position corresponding to the 80 mm width in order to support the paper.

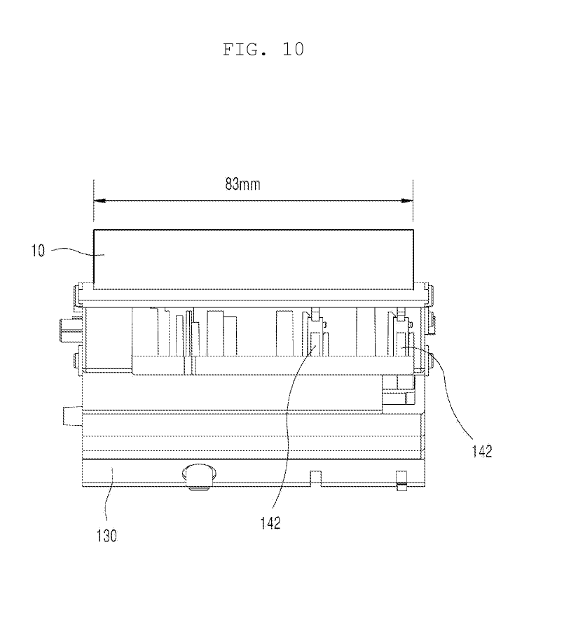

When the paper having an 83 mm width is used, as shown in FIG. 10, the entire width of the support frame 130 is used without the paper guide 150, and both the first switch contact 142 and the second switch contact 144 are switched off.

This information is transferred to the control section 160, which in turn sets the print width to 83 mm, so that the printing head can perform printing by the print width of 83 mm.

As described above, the switch contacts 140 detect the paper 10 based on the above-described combination that presents the relationship between the switch contacts 140 and the width size of the paper 10, and the detection results are transferred to the control section 160, which in turn sets the print width depending on the respective width size of the paper 10.

Accordingly, when the paper 10 is loaded in the support frame 130, the paper guide 150 supports the paper 10. The simple operation of loading the paper 10 in the support frame 130 makes it possible to automatically detect the width size of the paper 10 and thus automatically set the print width.

As described above, in the POS printer that uses the paper 10 having the form of a roll, the paper 10 having a variety of width sizes may be inserted into and fitted to the support frame 130, depending on conditions when the printer is used. In this case, the simple operation makes it possible to detect the width of the paper 10 and thus automatically set the print width by which printing is to be performed on the paper.

In the case of traditional printers of related art, which are available from the other companies, when it is intended to change the width of the paper depending on the condition where the printer is used, separate paper guide components must be assembled to the printer using screws or the like and a changed print width must be set using a utility program or the like. Since it is difficult for a salesman or the like in the store to conduct such an operation, an after service (A/S) is required, thereby inconveniencing the user.

However, in the invention, when the paper guide 150 is assembled to the support frame 130, the changed dimension can be be automatically set according to the paper 10 without an additional operation.

That is, the width size of the paper 10 is detected by the contact switching means and the paper guide 150, and the detected value is transferred to the control section 160, so that the utility matching the detected value is automatically set.

Here, in the apparatus for adjusting a print width in a POS printer according to an embodiment of the invention, the switch contacts 140 of the contact switching means are configured such that their positions can be adjusted in the lateral direction on the support frame 130.

When a new paper 10 having an irregular size is inserted into the support frame 130 for use, the positions of the contact switches 140 are adjusted to the right and left (in the lateral direction), so that they can detect the width size of the new paper 10. The detected width size is then transferred to the control section 160, which in turn sets the print width based on the detected width size of the new paper 10.

Accordingly, the paper guide 150 supports the paper 10 having a variety of sizes in the support frame 130, the width size of the paper 10 can be automatically detected, and the print width can be set based thereon.

As set forth above, the apparatus of the invention having the automatic detection function can automatically detect the width of the paper 10 using the paper guide 150 and the contact switch means when the paper 10 is inserted into the support frame 130, thereby increasing the convenience of the user.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable those skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for adjusting a print width in a point-of-sale printer, comprising:
a printer body having a printing head, wherein the printer body contains a paper therein;
a cover frame rotatably connected to an upper portion of the printer body, such that the upper portion of the printer body is opened and closed in order to replace the paper, the cover frame having a roller disposed on one end thereof;
a support frame coupled to an inside of the printer body, the support frame containing and holding the paper in an upper portion thereof, and supplying the paper to the printing head;
a contact switching means including a plurality of switch contacts at a plurality of positions that correspond to different width sizes of the paper to be inserted into the support frame, wherein the contact switching means is electrically connected or disconnected depending on a respective width size of the paper, thereby detecting the respective width size of the paper;
a paper guide capable of reciprocating in a lateral direction on the support frame, wherein a position of the paper guide is adjustable depending on the respective width size of the paper detected by the switch contacts, so that the paper guide supports the paper; and
a control section, wherein the control section recognizes the respective width size of the paper detected by the switch contacts, and sets and controls the print width.

2. The apparatus of claim 1, wherein, in the contact switching means, each of the switch contacts is electrically connected when one edge of the paper is brought close thereto depending on the respective width size of the paper, and is electrically disconnected when one edge of the paper is not close thereto or is covered by the paper.

3. The apparatus of claim 1, wherein, in the contact switching means, positions of the switch contacts are adjustable in the lateral direction on the support frame.

4. The apparatus of claim 1, wherein the paper guide variably supports the paper inside the support frame.

5. The apparatus of claim 1, wherein the control section sets and controls the contact switching means, the paper guide, and a printing range.

6. The apparatus of claim 5, wherein the control section automatically converts values that are set in a utility program by recognizing a signal from the switch contacts.
